(19) United States
(12) Patent Application Publication
(10) Pub. No.: US 2009/0101682 A1
(43) Pub. Date: Apr. 23, 2009

(54) Pour Spout

(75) Inventors: Alex S. Szekely, Jackson, NJ (US); Peter A. Piscopo, Medford, NJ (US)

Correspondence Address: BACHMAN & LAPOINTE, P.C., 900 CHAPEL STREET, SUITE 1201, NEW HAVEN, CT, 06510, US

(73) Assignee: PLASTEK INDUSTRIES, INC., Erie, PA (US)

(21) Appl. No.: 11/424,470

(22) Filed: Jun. 15, 2006

Related U.S. Application Data
(60) Provisional application No. 60/691,185, filed on Jun. 15, 2005.
(60) Provisional application No. 60/771,091, filed on Feb. 6, 2006.

(51) Int. Cl. B65D 5/74; B65D 41/04; B23P 11/00

(52) U.S. Cl. 222/562; 222/566; 29/428

(57) ABSTRACT

A container has a body with a body opening. A spout fitment is mounted within the body opening. A cap has a removed condition disengaged from the body and spout fitment. The cap has an installed condition threadingly mounted to at least one of the body and spout fitment. The spout fitment and body have first interfitting features positioned to resist an extraction of the spout fitment from the body. The spout fitment and body have second interfitting features positioned to angularly orient the spout fitment about an axis of the body opening.

### CROSS-REFERENCE TO RELATED APPLICATION

Benefit is claimed of U.S. Patent Application Ser. No. 60/691,185, filed Jun. 15, 2005, and entitled “Dispensing Systems” and U.S. Patent Application Ser. No. 60/771,091, filed Feb. 6, 2006, and entitled “Pour Spout”, the disclosures of which are incorporated by reference herein as if set forth at length.

### BACKGROUND OF THE INVENTION

The invention relates to containers. More particularly, the invention relates to pour spouts for containers for liquid laundry detergent and the like.

There has been an evolution in the configuration of containers for liquid laundry detergent, fabric softener, and the like. The dominant form of container is a wide mouth bottle having an attached spout with a drain-back trough and aperture. In a typical group of container configurations and their methods of assembly, a bottle, spout fitment, and cap are individually molded (e.g., of high density polyethylene (HDPE)). Exemplary bottle molding is via roto-molding whereas exemplary spout fitment and cap molding are by injection molding. An exemplary spout fitment includes the spout and a continuation of the spout defining the base and outboard wall of the trough. The fitment further typically includes a flange (e.g., extending outward at an upper end of the outboard extremity of the trough).

The spout fitment may be inserted through a mouth of the bottle (e.g., so that an outer surface of the outboard trough wall whereof another wall outboard thereof engages the inner surface of the bottle neck). The spout fitment may be secured and sealed to the bottle such as by spin welding. The bottle may be filled and the cap may be installed. Exemplary caps typically have either an externally threaded skirt for engaging an internally threaded portion of the fitment or an internally threaded skirt for engaging an externally threaded portion of the fitment or bottle neck. With a typical externally threaded skirt, the cap includes an outwardly projecting flange above the skirt. Upon installation of the cap to the fitment, the flange underside contacts and seals with the fitment flange upper surface to seal the bottle.

Various examples of bottles are shown in U.S. Pat. Nos. 6,923,341, 5,941,422, 5,566,862, and 5,603,787.

### SUMMARY OF THE INVENTION

One aspect of the invention involves a container having a body with a body opening. A spout fitment is mounted within the body opening. A cap has a removed condition disengaged from the body and spout fitment. The cap has an installed condition threadingly mounted to at least one of the body and spout fitment. The spout fitment and body have first interfitting features positioned to resist an extraction of the spout fitment from the body. The spout fitment and body have second interfitting features positioned to angularly orient the spout fitment about an axis of the body opening.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a bottle.

FIG. 2 is a side view of a cap, spout fitment, and body neck of the bottle of FIG. 1.

FIG. 3 is a sectional view of the bottle of FIG. 2.

FIG. 4 is an enlarged view of inter-engaged portions of the cap, spout fitment, and neck of the bottle of FIG. 3.

FIG. 5 is a rear view of the neck of the bottle of FIG. 1.

FIG. 6 is a view of the neck of FIG. 5.

FIG. 7 is a top view of the neck of FIG. 5.

FIG. 8 is a top view of the spout fitment of FIG. 2.

FIG. 9 is a view of the spout fitment of FIG. 8.

FIG. 10 is a vertical sectional view of the spout fitment of FIG. 8.

FIG. 11 is a side view of the cap of the bottle of FIG. 1.

FIG. 12 is a sectional view of a first alternate bottle.

FIG. 13 is a sectional view of a second alternate bottle.

FIG. 14 is a sectional view of a third alternate bottle.

FIG. 15 is a view of a neck of a body of the bottle of FIG. 14.

Like reference numbers and designations in the various drawings indicate like elements.

### DETAILED DESCRIPTION

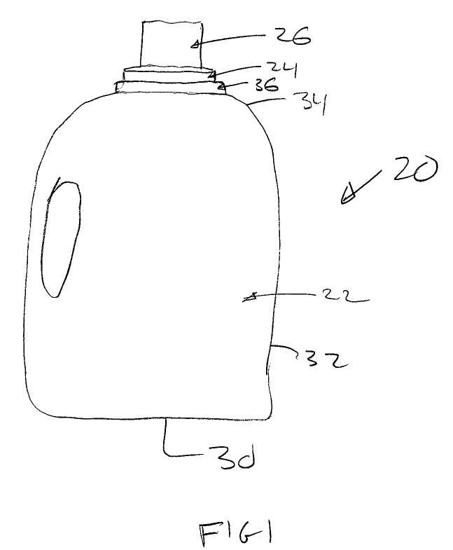

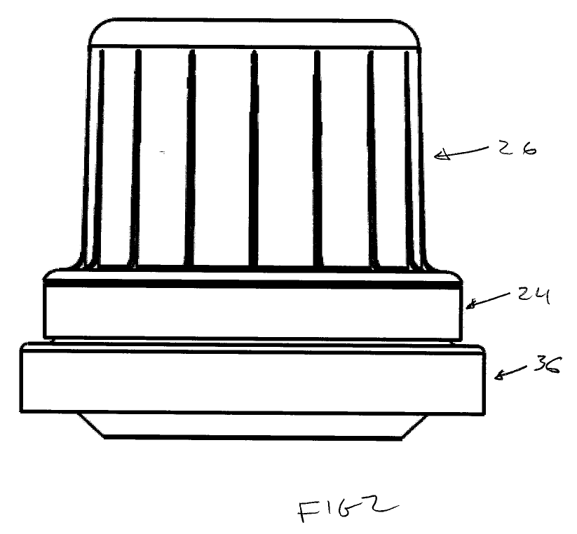

FIG. 1 shows a container 20 comprising the assembly of a bottle body 22, a spout fitment 24, and a cap 26 (which may serve as a measuring/dispensing cup). Each may be made as a unitary plastic molding. Exemplary bottle body material is high density polyethylene (HDPE). Exemplary spout fitment and cap material is polypropylene.

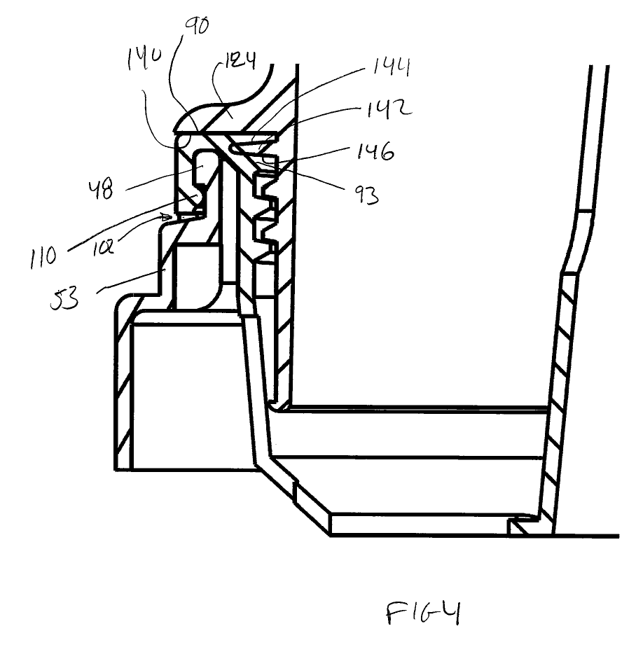

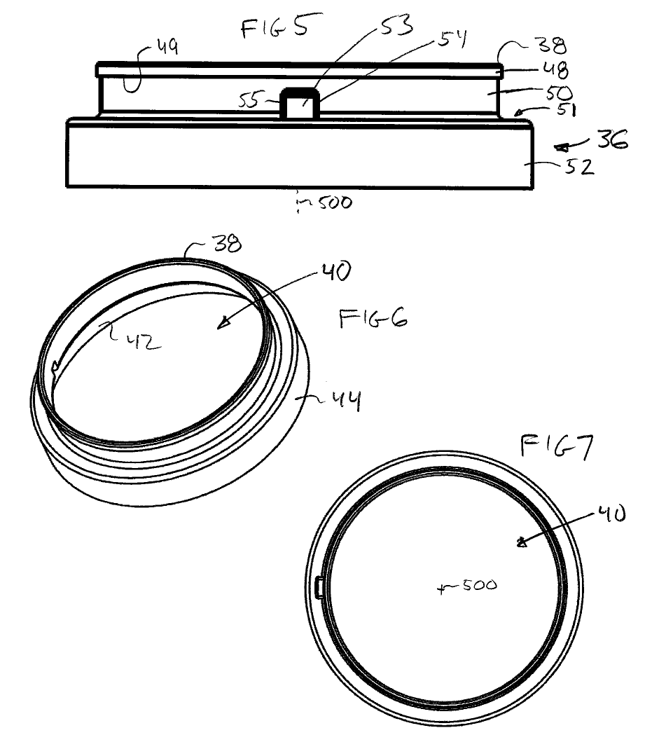

The body 22 comprises a unitary combination of a base 30, a sidewall 32 extending upward from the base, a shoulder 34 at an upper end of the sidewall, and a neck 36 extending upward from the shoulder. The neck 36 extends to a rim 38 (FIGS. 5-7) and defines an opening 40 having a central longitudinal axis 500. The bottle body has an interior surface 42 and an exterior surface 44. A handle 46 (FIG. 1) may extend from the sidewall and the body interior may extend through the handle.

The neck 36 (FIGS. 5-7) has an outwardly-projecting annular flange 48 at the rim 38. The flange 48 has an underside 49. A narrow region 50 extends downward below the flange 48 to a shoulder junction 51 with a wider region 52. A lug 53 extends upward from the junction 51 partially along the region 50 and has first and second circumferential ends/faces/surfaces 54 and 55. As is discussed below, the flange 48 helps retain the spout fitment to the neck while the lug 53 helps angularly orient the spout fitment about the axis 500.

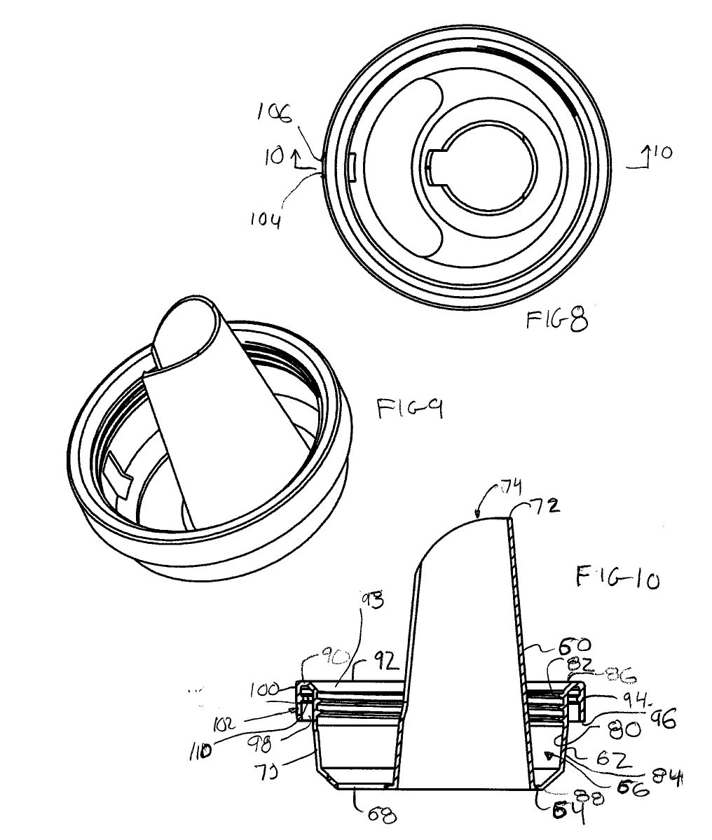

The spout fitment 24 (FIGS. 8-10) includes an inner wall 60 and an inner sidewall 62 joined by a lower wall 64 so as to define a trough 66. One or more drain-back apertures 68 along the trough base and/or vents 70 thereabove are open to the trough (e.g., through the wall 64 and sidewall 62, respectively). The inner wall 60 has an upper end 72 defining a spout opening 74. The upper end 72 peaks along a forward portion and dips along a rearward portion so that the opening 72 is asymmetric and defines a preferential direction for pouring.

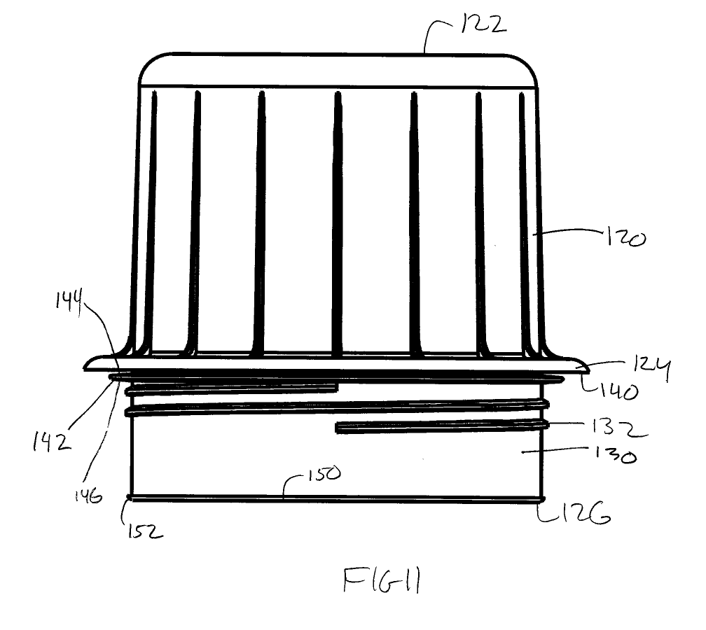

FIG. 10 shows the spout fitment sidewall 62 as having an inboard surface 80 bearing an internal thread 82. As is discussed further below, the internal thread helps engage the cap to the spout fitment. The sidewall has an external/outboard surface 84. The sidewall has an upper end 86 and a lower end 88. A flange 90 extends outward from the upper end 86. The flange 90 has an upper surface 92. A bevel/chamfer surface 93 above the thread 82 joins the flange upper surface 90 to a portion of the surface 80 therebelow. As is discussed further below, the surface 93 helps seal between the spout fitment and cap.

An outer sidewall 94 depends from an upper edge at an outboard periphery of the flange 90 to a lower end/rim 96. The outer sidewall 94 has an inboard surface 98 and an outboard surface 100. A recess 102 extends upward from the rim 96 and has first and second sides 104 and 106 (FIG. 8). As is discussed further below, the recess 102 captures the neck lug 53 so that adjacent surfaces of the recess and neck lug angularly retain the spout fitment relative to the neck.

The inboard surface 98 bears an annular projection 110. As is discussed below, whereas the recess 100 functions to orient the spout fitment on the body, the projection 110 cooperates with the projection 48 to provide a snap fit engagement retaining the spout fitment to the body.

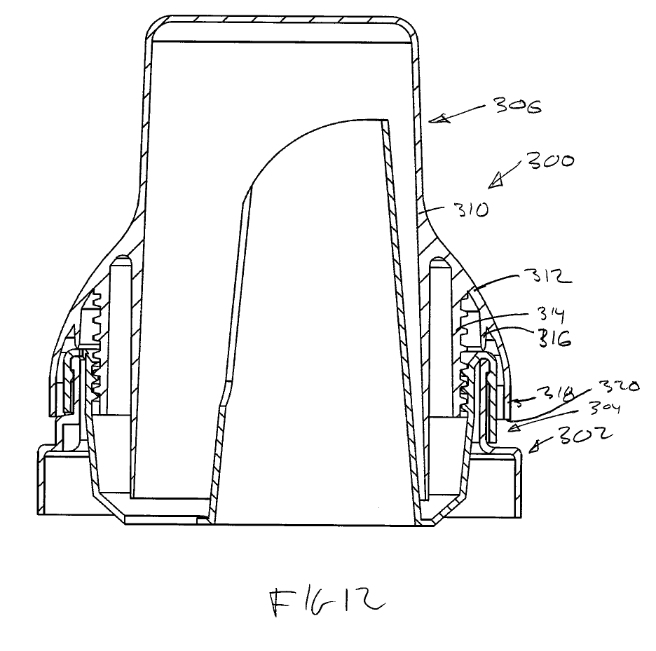

The cap 26 (FIG. 11) includes a sidewall 120, a transverse web 122 at the upper end of the sidewall, and an outwardly projecting flange 124 spaced above a lower end 126 of the sidewall. A lower portion 130 of the cap sidewall 120 depends below the flange 124 and bears an external thread 132 positioned for engaging the internal thread 82. The flange 124 has an underside 140. Spaced slightly below the flange 144 is an upper sealing flange 142 having an upper surface 144 and a lower surface/underside 146. Adjacent the lower end 126 of the sidewall, a lower sealing flange 150 is of relatively small radial extent and has a chamfer 152 merging an underside and a periphery.

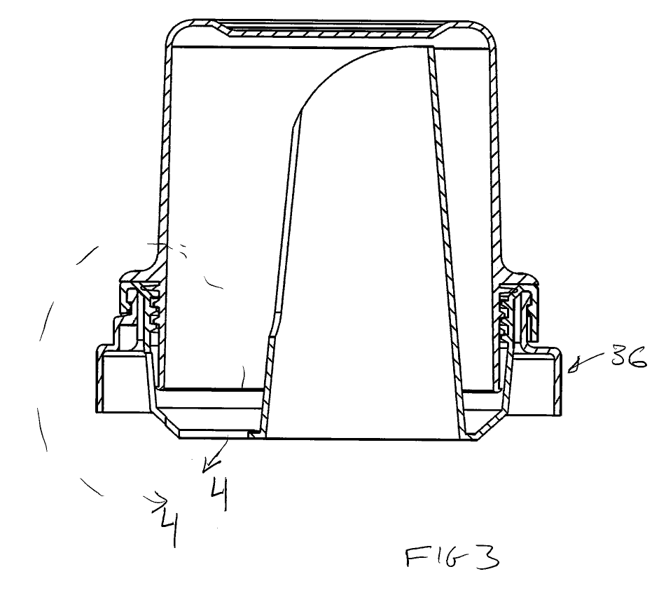

In an exemplary method of assembly, the cap is fully or partially screwed onto the spout fitment. The spout fitment is then installed to the bottle neck. In the cross-sectional views of FIGS. 3 and 4, parts are shown generated from a solid model and not reflecting strain. Accordingly, interference is shown which would produce strains described below. As the cap is screwed into place, the underside 146 of the flange 142 (FIG. 4) will come into engagement with the surface 93. Further screwing of the cap onto the spout fitment will flex the flange 142 upward, increasing stress and strain and providing a sealing bias.

The flange 124 may be positioned to protect the flange 142 in one or more ways. First engagement between an outboard portion of the underside 140 of the relatively robust flange 124 and the rim surface 90 may act as a stop restricting further relative screwing rotation of the cap relative to the spout fitment. Additionally, the underside 140 may be positioned in sufficiently close proximity to the upper surface 144 that flexing of the flange 142 brings its upper surface 144 into engagement with the underside 140 so that the flange 124 also acts as a backing flange.

In the FIG. 4 example, the cap and spout fitment subassembly may be installed to the body neck by a linear insertion. During the insertion, the lug 53 is aligned with the recess 102. An initial stage of the insertion may produce a camming action between the projections 48 and 110. Further insertion causes the recess to receive the lug and the projection 110 to snap over the projection 48 and at least partially relax. Advantageously, the relaxation is only partial, sufficient to provide a mechanical backlocking to resist spout fitment extraction yet leaving stress/strain sufficient to maintain a sealing engagement between the spout fitment and neck. Advantageously, this sealing engagement remains when the cap is unscrewed. However, the engagement of the cap (in particular the flange 142) with the spout fitment may provide a sandwiching engagement further strengthening the seal between the spout fitment and neck. Thus, the dimensions of the spout fitment and neck are advantageously such that, in the absence of the cap, their interference contact is sufficient to provide sealing under normal loads associated with pouring. The addition of the cap may further augment sealing to higher levels to address loads associated with transport and handling.

FIG. 12 shows an alternate embodiment 300 having a neck 302, a spout fitment 304, and a cap 306. The neck-to-spout fitment engagement may be similar to that described above. The cap-to-spout fitment engagement differs. The cap has a main sidewall 310 which defines the cup of the cap. A bell flange 312 depends from a central location of the sidewall 310. An externally threaded intermediate wall 314 depends from a relatively inboard portion of the bell flange spaced slightly apart from the sidewall 310. The external thread engages the internal thread of the spout fitment. Outboard of the intermediate sidewall 314, a v-bead land seal 316 depends from the bell flange 312. The rim of the seal 316 maintains sealing contact with the rim of the spout fitment when the cap is installed. A terminal skirt 318 of the flange 312 may extend to a rim 320 and surround at least an upper portion of the outer/outboard sidewall of the spout fitment.

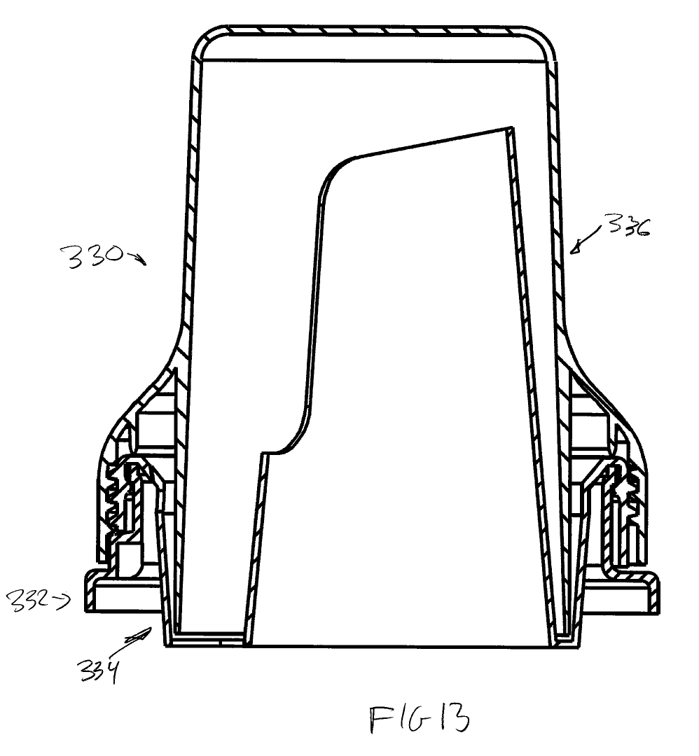

FIG. 13 shows a second alternate embodiment 330 having a neck 332, a spout fitment 334, and a cap 336. Snap-fit engagement between the spout fitment and neck may be as described above. Relative to the embodiment 300, the cap-to-spout fitment threading is shifted outward with an external thread on the spout fitment outer sidewall and an internal thread on the cap bell flange outboard of the v-bead land seal.

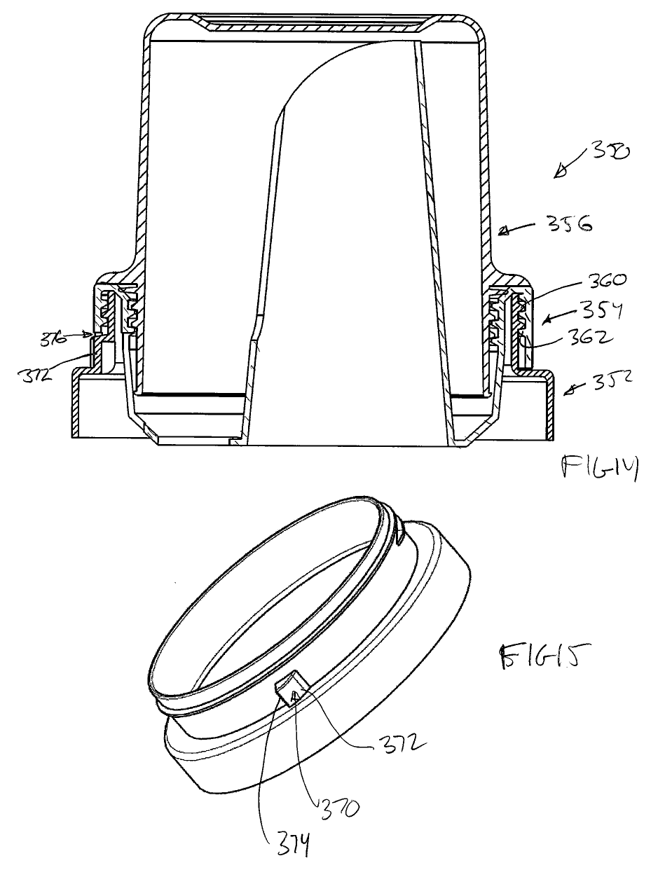

FIGS. 14 and 15 show a third alternate embodiment 350 having a neck 352, a spout fitment 354, and a cap 356. The cap-to-spout fitment engagement may be similar to that of the first embodiment shown in section in FIGS. 3 and 4. The neck-to-spout fitment engagement differs in that the snap fit of non-thread projections is replaced with a threaded engagement between an external thread 360 of the neck and an internal thread 362 of the spout fitment outer sidewall. The neck lug 370 is modified to have a camming surface 372 and a locking surface 374. These cooperate with an otherwise similar recess 376 in the spout fitment outer sidewall. To install the spout fitment to the neck, the threads 362 are screwed on to the threads 360. During the rotation of this screwing, the camming surface may allow the recess to pass over the lug. However, the recess and lug are positioned so that the lug will be within the recess when the spout fitment is in a desired fully installed condition. At this point, unscrewing is prevented by backlocked interaction of the locking surface 374 with the adjacent surface of the recess 376.

Various implementations may have one or more of various advantages. One group of advantages relate to elimination of welding or adhering of the spout fitment to the bottle body. In addition to the economy of a saved step, this may facilitate delivery of the liquid before attaching the spout fitment to the bottle body which may allow more efficient processing (e.g., including higher flow delivery or less precisely aimed delivery through an opening in the bottle body larger than the spout opening). The spout fitments and caps may be delivered to the bottler as units and installed in units, thereby easing installation. Other potential advantages include weight reduction and reduced intrusion of the spout fitment into the bottle body (thereby permitting higher fill levels). Other potential advantages include improved sealing. Finally, there may be greater flexibility in aesthetics by permitting relatively easy use of differently-styled spout fitments with a given bottle body or differently styled bottle bodies with a given spout fitment.

One or more embodiments of the present invention have been described. Nevertheless, it will be understood that various modifications may be made without departing from the spirit and scope of the invention. For example, when implemented in the reengineering of an existing container configuration, details of the existing configuration may influence or dictate details of any particular implementation. Accordingly, other embodiments are within the scope of the following claims.

1. A container comprising:
a body having a body opening;
a spout fitment within the body opening; and
a cap having:
a removed condition disengaged from the body and spout fitment; and
an installed condition threadingly mounted to at least one of the body and spout fitment,
wherein the spout fitment and body have:
first interfitting features positioned to resist an extraction of the spout fitment from the body; and
second interfitting features positioned to angularly orient the spout fitment about an axis of the body opening,
wherein:
the first interfitting features comprise:
an inwardly-directed first non-thread projection of the spout fitment; and an outwardly-directed second non-thread projection of the body.

2. (canceled)

3. (canceled)

4. (canceled)

5. The container of claim 1 wherein:
the second interfitting features comprise:
a recess in a sidewall of the spout fitment; and
a lug of the body.

6. The container of claim 1 wherein:
the fitment comprises a trough with at least one drain aperture.

7. The container of claim 1 wherein:
a portion of the cap is externally threaded to threadingly engage an internally threaded portion of the fitment.

8. The container of claim 1 wherein:
a portion of the cap is internally threaded to threadingly engage an externally threaded portion of the body.

9. The container of claim 1 wherein:
the body consists essentially of HDPE;
the spout fitment consists essentially of polypropylene; and
the cap consists essentially of polypropylene.

10. The container of claim 1 wherein:
the body has an integrally molded handle; and
an interior compartment of the body extends through the handle.

11. The container of claim 1 wherein:
the fitment is neither adhered nor welded to the body.

12. The container of claim 1 further comprising:
1.0-6.0 liters of a liquid within the body.

13. The container of claim 1 further comprising:
at least 1.0 liter of liquid detergent or fabric softener within the body.

14. A container cap and spout assembly comprising:
a spout fitment having:
a first thread;
a spout having an opening;
a first sidewall;
a trough between the spout and the first sidewall; and
a drain aperture open to the trough; and
a second sidewall outboard of the first sidewall and having a non-thread internal projection and a recess;
a cap having:
a first thread engaged to the spout fitment first thread.

15. The assembly of claim 14 wherein:
the opening is asymmetric.

16. The assembly of claim 14 consisting essentially of the spout fitment and cap, each consisting essentially of a single molding.

17. The assembly of claim 14 wherein:
the body consists essentially of HDPE;
the spout fitment consists essentially of polypropylene; and
the cap consists essentially of polypropylene.

18. A container body comprising the unitarily molded combination of:
a base;
a sidewall extending upward from the base;
a neck having:
a distal first portion defining an opening;
an unthreaded second portion below the first portion; and
a third portion below the second portion,
wherein an exterior surface of the neck has:
a circular cross-section along at least part of the second portion; and
at least one outward projection in the second portion.

19. The container body of claim 18 further comprising:
an outwardly projecting flange at the first portion.

20. The container body of claim 19 wherein:
no one of the at least one outward projection has a circumferential extent more than 10°.

21. The container body of claim 19 wherein:
the projection is vertically recessed from the flange.

22. The container body of claim 18 wherein:
the neck is unthreaded.

23. A method comprising:
installing a spout fitment into a neck portion of a container body, the installing comprising a resilient deformation of at least one of the spout fitment and bottle body followed by an at least partial relaxation so as to engage a locking surface of the spout fitment to a locking surface of the bottle to resist a reverse of the installing; and
threading a cap onto at least one of the spout fitment and container body, wherein:
the installing consists essentially of a linear insertion; and
the installing flexes an outer sidewall of the spout fitment, the spout fitment locking surface comprising a trailing end of an inward projection of the outer sidewall.

24. The method of claim 23 wherein:
the threading is at least partially before the installing.

25. (canceled)

26. The method of claim 23 wherein the insertion causes a recess in the spout fitment to capture a lug on the neck portion.

27. (canceled)

28. (canceled)

29. The method of claim 23 further comprising:
delivering at least 1.0 liter of a liquid into the container body.

30. The method of claim 29 wherein:
the delivering is before the inserting.

31. The method of claim 29 wherein:
there is no welding or adhesive bonding of the spout fitment to the container body before the delivering.
